(19) United States
(12) Patent Application Publication
(10) Pub. No.: US 2009/0078205 A1
(43) Pub. Date: Mar. 26, 2009

(54) METHODS AND APPARATUS FOR DETERMINING WHETHER EGGS HAVE BEEN REMOVED FROM AN EGG CARRIER

(75) Inventor: John H. Hebrank, Durham, NC (US)

Correspondence Address: MYERS BIGEL SIBLEY & SAJOVEC, PO BOX 37428, RALEIGH, NC, 27627, US

(73) Assignee: Embrex, Inc.

(21) Appl. No.: 11/859,285

(22) Filed: Sep. 21, 2007

(51) Int. Cl. A01K 45/00

(52) U.S. Cl. 119/6.8

(57) ABSTRACT

Methods and apparatus are provided that automatically determine whether or not eggs designated for removal from an egg carrier have been removed by an egg removal apparatus. Light is emitted along a path above and across an egg carrier. An egg picker is moved from a first location overlying the carrier to a second location in contacting relationship with an egg in the carrier and back towards the first location, and is configured to engage the egg when in the second location and remove the egg from the carrier when moved from the second location towards the first location. The length of time that the light path is blocked when the egg picker is moved from the first location to the second location and back towards the first location is measured. A signal that indicates whether or not the egg has been removed from the carrier based on the length of time the light path is blocked is generated.

### FIELD OF THE INVENTION

The present invention relates generally to eggs and, more particularly, to methods and apparatus for handling eggs.

### BACKGROUND

Eggs which are to be hatched to live poultry are typically candled during embryonic development to identify clear, rotted, and dead eggs (collectively referred to as “non-live eggs”). Non-live eggs are typically removed from incubation to increase available incubator space. In addition, removing non-live eggs can increase hatch rates by as much as 2.0% in old flocks (flock age: 58-62 weeks). This hatch improvement can have a direct value increase of about 0.2 to 0.4¢ per chick in the United States.

In many instances it is desirable to introduce a substance into a live egg prior to hatch. Advances in poultry embryology have made possible the addition of various materials to the embryo or to the environment around the embryo within an avian egg for the purpose of encouraging beneficial effects in the subsequently hatched chick. Such beneficial effects include increased growth, prevention of disease, increasing the percentage hatch of multiple incubated eggs, and otherwise improving physical characteristics of hatched poultry. Additionally, certain types of vaccinations which could previously only be carried out upon either recently hatched or fully mature poultry can now be successful in the embryonated chick. Examples of substances that have been used for, or proposed for, in ovo injection include vaccines, antibiotics and vitamins. In ovo treatment substances and methods of in ovo injection are described, for example, in U.S. Pat. No. 4,458,630 to Sharma et al. and U.S. Pat. No. 5,028,421 to Fredericksen et al.

Unfortunately, it may not be desirable to administer vaccinations into every egg contained within an egg flat. For example, clear eggs are eggs that do not contain an embryo and, thus, may not subsequently hatch as a chick. Clear eggs are conventionally removed prior to in ovo injection because the administration of vaccinations into clear eggs generally serves no purpose and may be considered wasteful. In addition, mold may grow in clear eggs that have been injected, thus increasing the risk of exposing other eggs and hatched chicks to undesirable contamination. Furthermore, injected clear eggs may increase the risk of contamination resulting from albumin leaking therefrom. Dead eggs and rotted eggs are also conventionally removed prior to in ovo injection. Accordingly, it is desirable to quickly identify and remove non-live eggs from an egg flat prior to the in ovo administration of vaccinations via automatic inoculating devices.

In the manufacture of human flu vaccines, seed viruses are inoculated into live eggs and then three days later virus material is harvested in batches of eggs. Dead or rotted eggs can contaminate batches of virus harvested from live eggs so that reliable removal of detected non-live eggs is important to minimize contamination and bioburden in harvests. Removal system malfunctions are likely since eggs have holes where they were inoculated and egg goo pulled from the punch hole tends to plug vacuum lines of removal apparatus. In this application small numbers of eggs are typically removed, perhaps 2% to 5%, and human access to harvesting operations for some types of flu vaccines are highly restricted so that a reliable removal is valuable for both economic and health reasons.

It may also be desirable to selectively remove other types of eggs from an egg flat. For example, it may be desirable to remove all male eggs, all female eggs, etc. As another example, it may be desirable to remove all live eggs in order to move them to another egg flat or injection apparatus.

Conventional egg handling devices remove eggs from egg flats by pulling the eggs with a vacuum cup of a suction device. The vacuum cup generally lifts the eggs vertically from a flat and carries them to a disposal location. A conventional device 10 for removing eggs 12 from an egg flat 14 is illustrated in FIG. 1. A plurality of “egg pickers” 16 are configured to engage the upwardly facing portions of a respective plurality of individual eggs 12 within the flat 14, and hold the eggs by suction while carrying them to a receptacle 18.

Sometimes eggs to be removed from a flat cannot be removed by an egg removal device. For example, an egg may be tightly wedged in the pocket of a flat. In addition, spilled egg contents and other foreign matter may act as an adhesive that binds an egg within a pocket of a flat. Conventional suction devices may fail to remove an egg from a flat for other reasons, as well. For example, the vacuum cup of a suction device may fail to seat adequately on an egg, or vacuum leaks may occur because of a feather or other debris on the egg shell, or because of a crack in the egg shell. In addition, a suction device may not be able to remove an egg when there is insufficient vacuum, which may have various causes, such as a torn vacuum cup, clogged venturi or vacuum line, etc. Unfortunately, conventional egg removal systems do not have a way of detecting when an egg that should be removed from a flat is not removed.

### SUMMARY

In view of the above discussion, methods and apparatus are provided for automatically determining whether or not eggs designated for removal from an egg carrier have been removed. According to some embodiments of the present invention, a method of removing an egg from an egg carrier includes emitting light along a path above and across an egg carrier; moving an egg picker (and/or an assembly supporting the egg picker) from a first location to a second location in contacting relationship with an egg in the carrier and back to the first location, wherein the egg picker is configured to engage the egg when in the second location and remove the egg from the carrier when moved from the second location to the first location; measuring a length of time that the light path is blocked when the egg picker is moved from the first location to the second location and back towards the first location; and generating a signal that indicates whether or not the egg has been removed from the carrier based on the length of time the light path is blocked, thereby identifying that the egg picker is not operating properly.

In some embodiments, a signal is generated that indicates that an egg has not been removed from the carrier when the measured length of time that the light path is blocked is less than a predetermined length of time. A signal may be generated that indicates that an egg has been removed from the carrier when the measured length of time that the light path is blocked is greater than a predetermined length of time. In some embodiments, an alarm is activated in response to generating a signal that indicates that the egg has not been removed from the carrier.

According to other embodiments of the present invention, a method of removing an egg from an egg carrier includes monitoring an optical path above and across an egg carrier; moving an egg picker (and/or an assembly supporting the egg picker) from a first location to a second location in contacting relationship with an egg in the carrier and back towards the first location, wherein the egg picker is configured to engage the egg when in the second location and remove the egg from the carrier when moved from the second location towards the first location; measuring a length of time that the optical path is blocked when the egg picker is moved from the first location to the second location and back towards the first location; and generating a signal that indicates whether or not the egg has been removed from the carrier based on the length of time the optical path is blocked, thereby identifying that the egg picker is not operating properly.

In some embodiments, a signal is generated that indicates that an egg has not been removed from the carrier when the measured length of time that the optical path is blocked is less than a predetermined length of time. A signal may be generated that indicates that an egg has been removed from the carrier when the measured length of time that the optical path is blocked is greater than a predetermined length of time. In some embodiments, an alarm is activated in response to generating a signal that indicates that the egg has not been removed from the carrier.

According to other embodiments of the present invention, an apparatus for removing eggs from an egg carrier includes an egg picker that is movable between a first location and a second location in contacting relationship with an egg in the carrier, a light source positioned on one side of the carrier that emits light along a path above and across the carrier, and a light detector positioned on an opposite side of the carrier. The egg picker is configured to engage the egg when in the second location and to remove the egg from the carrier when moved from the second location to the first location. The light detector is configured to measure a length of time that the light path is blocked when the egg picker is moved from the first location to the second location and back towards the first location. The light detector generates a signal that indicates whether or not the egg has been removed from the carrier based on the length of time the light path is blocked, thereby identifying that the egg picker is not operating properly.

In some embodiments, a signal is generated by the light detector that indicates that an egg has not been removed from the carrier when the measured length of time that the light path is blocked is less than a predetermined length of time. A signal may be generated by the light detector that indicates that an egg has been removed from the carrier when the measured length of time that the light path is blocked is greater than a predetermined length of time. In some embodiments, an alarm is activated in response to a signal indicating that the egg has not been removed from the carrier.

According to other embodiments of the present invention, an apparatus for removing eggs from an egg carrier includes an egg picker that is movable between a first location overlying a carrier and a second location in contacting relationship with an egg in the carrier, and a camera positioned on one side of the carrier that captures an optical path above and across the carrier. The egg picker is configured to engage the egg when in the second location and to remove the egg from the carrier when moved from the second location towards the first location. The camera is configured to measure a length of time that the optical path is blocked when the egg picker is moved from the first location to the second location and back to the first location. The camera generates a signal that indicates whether or not the egg has been removed from the carrier based on the length of time the optical path is blocked.

In some embodiments, a signal is generated by the camera that indicates that an egg has not been removed from the carrier when the measured length of time that the optical path is blocked is less than a predetermined length of time. A signal may be generated by the camera that indicates that an egg has been removed from the carrier when the measured length of time that the optical path is blocked is greater than a predetermined length of time. In some embodiments, an alarm is activated in response to a signal indicating that the egg has not been removed from the carrier.

According to other embodiments of the present invention, an apparatus for removing eggs from an egg carrier includes an egg picker that is movable between a first location overlying a carrier and a second location in contacting relationship with an egg in the carrier, and a detector positioned adjacent to the carrier. The detector is configured to monitor a path above and across the carrier and to measure a length of time that the path is blocked when the egg picker is moved from the first location to the second location and back to the first location. The detector is configured to generate a signal that indicates whether or not an egg has been removed from the carrier based on the length of time the path is blocked. For example, the detector may generate a signal that indicates that an egg has not been removed from the carrier when the measured length of time that the path is blocked is less than a predetermined length of time. The detector may be configured to generate a signal that indicates that an egg has been removed from the carrier when the measured length of time that the path is blocked is greater than a predetermined length of time.

According to some embodiments of the present invention, a method of detecting a malfunctioning egg picker in an apparatus for removing eggs from an egg carrier, includes counting the number of times an egg picker fails to remove an egg designated for removal from the carrier, and generating a signal that indicates that the egg picker is malfunctioning when the number of times exceeds a predetermined number and/or a predetermined percentage.

According to some embodiments of the present invention, a method of detecting a malfunctioning egg picker in an apparatus for removing eggs from an egg carrier, includes determining the specific picker in a row that failed to remove an egg by combining the information that an egg was not picked from a row with the specific picker in the row activated to pick an egg and counting the number of times an egg picker fails to remove an egg designated for removal from the carrier, and generating a signal that indicates that the egg picker is malfunctioning when the number of times exceeds a predetermined number and/or a predetermined percentage.

According to some embodiments of the present invention, a method of detecting a malfunctioning egg picker in an apparatus for removing eggs from an egg carrier includes counting, via an optical system positioned adjacent to the carrier, the number of times any of the egg pickers in the apparatus fails to remove an egg designated for removal from the carrier, and generating a signal that indicates that an egg picker is malfunctioning when the number of times exceeds a predetermined number. The optical system may include, for example, a camera positioned above or below the carrier.

### BRIEF DESCRIPTION OF THE DRAWINGS

FIG. 1 illustrates a conventional device for removing eggs from an egg flat.

FIG. 2A is a top plan view of an egg flat containing eggs therein.

FIG. 2B is a side view of the egg flat of FIG. 2A taken along lines 2B-2B.

FIGS. 3A-3C and 4A-4C illustrate methods and apparatus for determining if eggs designated for removal from an egg flat have been removed, according to some embodiments of the present invention.

FIGS. 5 and 6 illustrate methods and apparatus for determining if eggs designated for removal from an egg flat have been removed, according to other embodiments of the present invention.

FIG. 7 is a top plan view of an egg flat with a plurality of light sources positioned on one side thereof, and a plurality of light detectors positioned on an opposite side thereof, in accordance with some embodiments of the present invention.

FIG. 8 is a top plan view of an egg flat with a plurality of cameras positioned on one side thereof, in accordance with some embodiments of the present invention.

FIG. 9 is a block diagram of an egg processing system, according to some embodiments of the present invention.

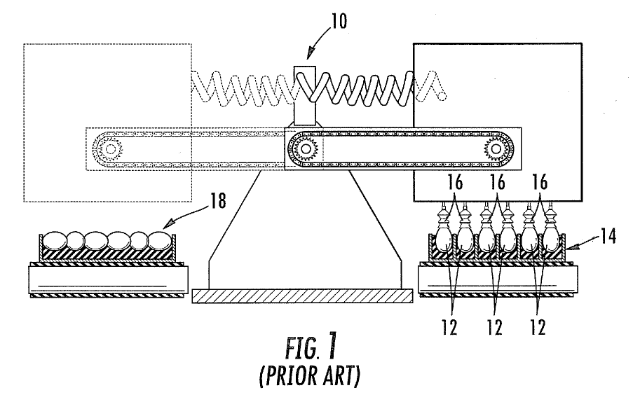

### DETAILED DESCRIPTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention. The sequence of operations (or steps) is not limited to the order presented in the claims or figures unless specifically indicated otherwise.

As would be understood by one skilled in the art, eggs are incubated and processed within a carrier, such as an egg flat. Flats may contain any number of rows, such as seven rows of eggs, with rows of six and seven being most common. Moreover, eggs in adjacent rows may be parallel to one another, as in a “rectangular” flat, or may be in a staggered relationship, as in an “offset” flat. Examples of suitable commercial flats include, but are not limited to, the “CHICKMASTER 54” flat, the “JAMESWAY 42” flat and the “JAMESWAY 84” flat (in each case, the number indicates the number of eggs carried by the flat). Egg flats are well known to those of skill in the art and need not be described further herein.

The term “egg picker” refers to any type of device capable of removing an egg from the pocket of an egg carrier, such as an egg flat.

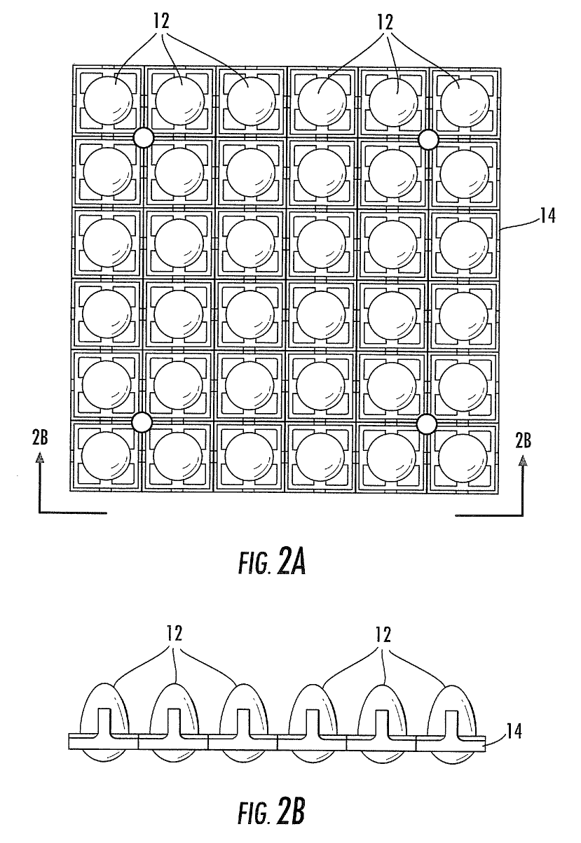

The terms “flat” and “carrier” are intended to be used interchangeably herein. Moreover, embodiments of the present invention may be utilized with any type of device configured to transport a plurality of eggs. The term “egg carrier” is intended to include all such devices. FIG. 2A is a plan view of an exemplary egg carrier 14 containing an array of eggs 12 therein that is used to illustrate various embodiments of the present invention. FIG. 2B is a side view of the egg carrier 14 of FIG. 2A taken along lines 2B-2B.

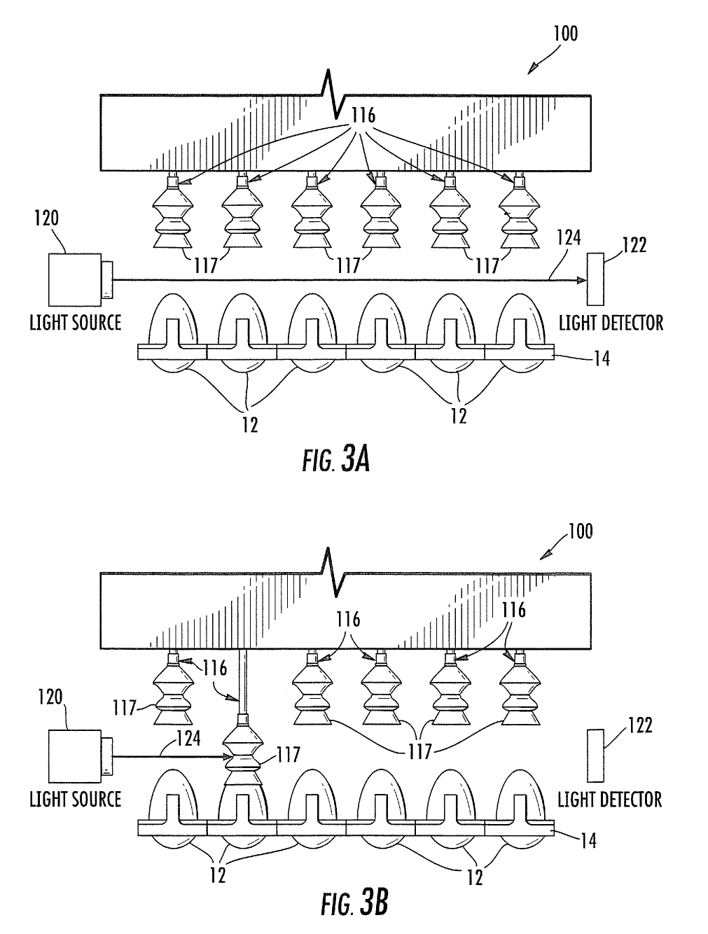

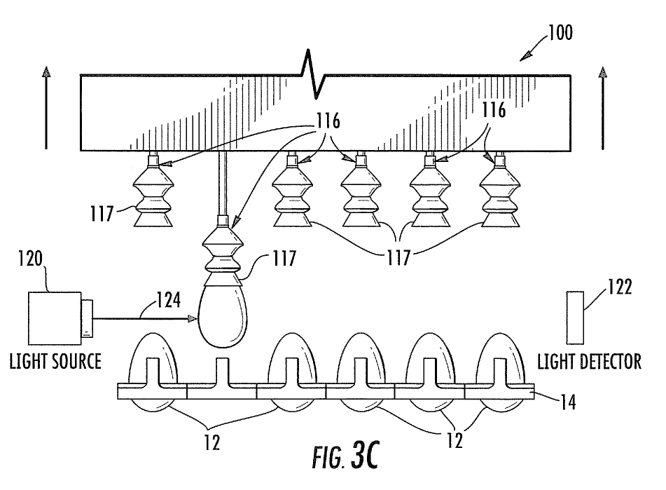

FIGS. 3A-3C and 4A-4C illustrate methods and apparatus for determining if eggs designated for removal have, in fact, been removed from an egg carrier, according to some embodiments of the present invention. In FIG. 3A, the illustrated egg removal apparatus 100 includes a plurality of egg pickers 116 for each row of an egg carrier 14. The egg pickers 116 are movable between a first location (FIG. 3A) and a second location in contacting relationship with a respective plurality of eggs in a carrier 14 (FIG. 3B). In the illustrated embodiment, the egg pickers 116 are individually movable between respective first (i.e., raised) and second (i.e., lowered) locations. However, embodiments of the present invention may be utilized with egg removal devices wherein egg pickers do not move individually, i.e., where a plurality or all of the egg pickers move in concert between first and second locations to remove eggs, for example where egg pickers move via movement of the egg removal apparatus 100. In other embodiments, egg picker 116 movement may be achieved via a combination of individual egg picker movement and egg removal apparatus 100 movement. In other words, egg picker 116 movement discussed herein with the various embodiments may be individual egg picker movement, movement of the egg removal apparatus 100 or a combination of egg removal apparatus 100 movement and individual egg picker 116 movement.

Movement of an egg picker 116 as discussed herein with respect to the various embodiments is not limited to substantially vertical movement relative to an egg carrier 14. An egg picker first location may be a location that is lateral to an egg carrier. In other words, an egg carrier may move from a location adjacent an egg carrier 14, engage an egg, and then move back to a location that is lateral to the egg carrier 14 to drop the removed egg. Egg picker movement, thus, is not limited to the illustrated movement in the figures.

Each illustrated egg picker 116 is configured to engage a respective egg 12 when in the second location and to remove the egg 12 from the carrier 14 when moved from the second location towards the first location. The illustrated egg pickers 116 each have a flexible cup 117 that is configured to engage and retain an egg in seated relation therewith when subatmospheric pressure is provided within the flexible cup 117, as would be understood by those skilled in the art of egg removal devices.

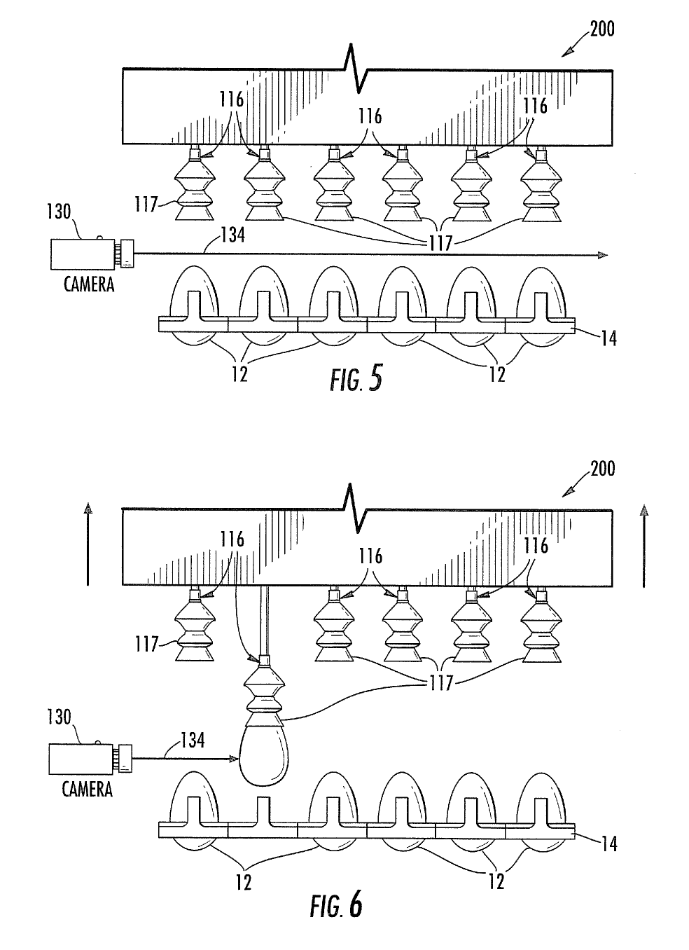

A light source/light detector pair 120, 122 is provided for each row of the carrier 14 (see FIG. 7). The light sources 120 are positioned on one side of the carrier 14, as illustrated. Each light source 120 emits light along a path above and across a respective row of the carrier 14. The light detectors 122 are positioned on an opposite side of the carrier 14. Each light detector 122 is configured to measure a length of time that a respective light path is blocked when an egg picker 116 associated with a respective row is moved from the first location to the second location and back towards the first location.

For example, in FIG. 3A, the light source 120 emits light along path 124 that is detected by light detector 122. The light path is not blocked by any of the egg pickers 116 or eggs 12 because none of the egg pickers have moved downwardly towards the second location to remove an egg. In FIG. 3B, the second egg picker 116 is lowered to remove the second egg in the row (which has been designated for removal) and the flexible cup 117 of the egg picker 116 blocks the light path. The egg is engaged by the egg picker 116 when the egg picker 116 reaches the second location and then moves upwardly to the first location, so that the removed egg can be disposed of. As illustrated in FIG. 3C, the egg removed by the egg picker 116 blocks the light path when the egg picker 116 is at the second location. As such, when an egg is successfully removed from the egg carrier 14, a light path 124 will be blocked as the egg picker 116 moves downwardly to the second location and then back to the first location.

If an egg is not engaged by an egg picker 116 (i.e., an egg picker fails to remove an egg from a carrier), the light path 124 would become unblocked as the egg picker flexible cup 117 moved upwardly past the light path to the second location, as illustrated in FIG. 4C. In FIGS. 4A-4C, the sequence of unsuccessfully removing an egg from the carrier 14 is illustrated. As illustrated, when an egg designated for removal is not successfully removed from the egg carrier, the light path is blocked for a shorter period of time than when an egg is successfully removed. Thus, the light detector 122 for each row of a carrier 14 can quickly determine if eggs designated for removal have, in fact, been removed based on whether the measured length of time that the light path is blocked is less than a predetermined length of time. This predetermined period of time can be set by lowering and raising one or more of the egg pickers 116 without the presence of egg in a carrier, such as during initialization of an egg removal device.

According to some embodiments of the present invention, each light detector 122 is configured to generate a signal that indicates whether or not eggs designated for removal in a row have in fact been removed based on the length of time a respective light path 124 is blocked. For example, each light detector 122 can generate a signal that indicates that eggs in a respective row designated for removal have been removed from a carrier 14 when the measured length of time that the light path is blocked is greater than a predetermined length of time. Similarly, each light detector 122 can generate a signal that indicates that one or more eggs designated for removal in a respective row have not been removed from a carrier 14 when the measured length of time that the light path is blocked is less than a predetermined length of time.

Signals generated by a light detector 122 may be communicated to a controller for the egg removal apparatus 100. The controller may direct the egg removal apparatus 100 to try again to remove the egg. Alternatively, the controller may signal an operator that an egg was unsuccessfully removed, etc. According to some embodiments of the present invention, when an egg has been detected as not having been successfully removed from the carrier, a light detector 122 can communicate a signal to an alarm that becomes activated so as to notify an operator of the unsuccessful removal. Exemplary alarms include audible alarms, visible alarms, alarms on a user interface associated with the egg removal apparatus 100, etc. For example, according to some embodiments of the present invention, the egg removal apparatus 100 may include a user interface that displays a graphical representation of an egg carrier, including each egg pocket therein. The user interface, as a result of communications from the various light detectors 122 can indicate which rows and/or egg pockets in the carrier 14 contain an egg that was unsuccessfully removed therefrom.

Embodiments of the present invention are not limited to the illustrated arrangement of light source/detector pairs 120, 122. According to other embodiments of the present invention, another set of light source/detector pairs may also be utilized along the rows that are oriented orthogonal to the rows of FIG. 7 having light source/detector pairs positioned adjacent thereto. In addition, embodiments of the present invention are not limited to the illustrated egg pickers 116. Embodiments of the present invention may be utilized with any type of apparatus configured to remove eggs from a carrier. In some embodiments, a camera may be positioned above an egg carrier (e.g., substantially orthogonal thereto, etc.) to confirm that eggs designated for-removal have, in fact, been removed.

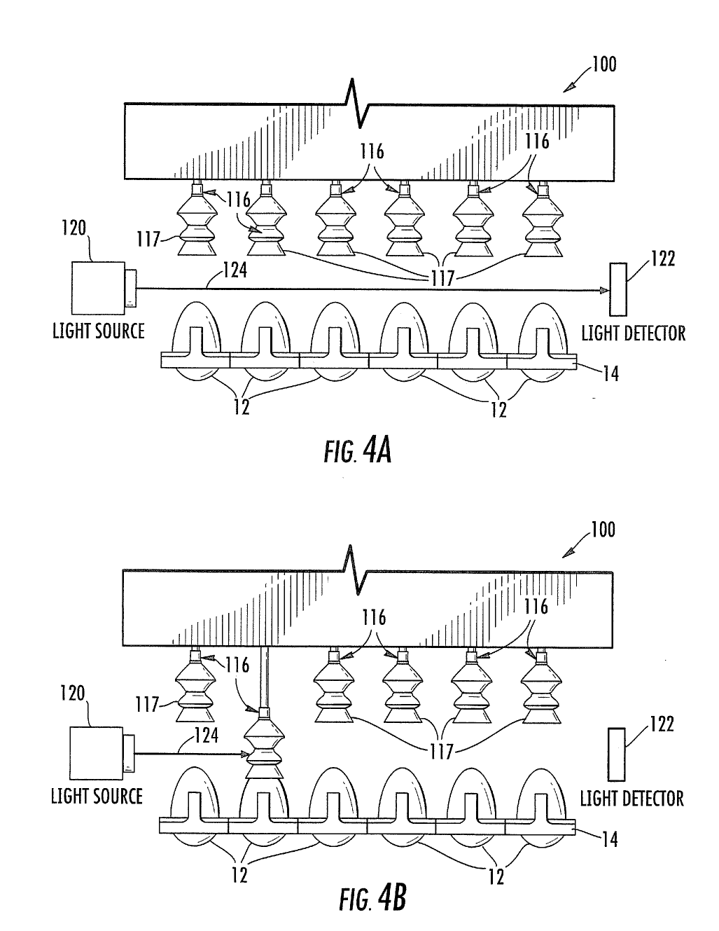

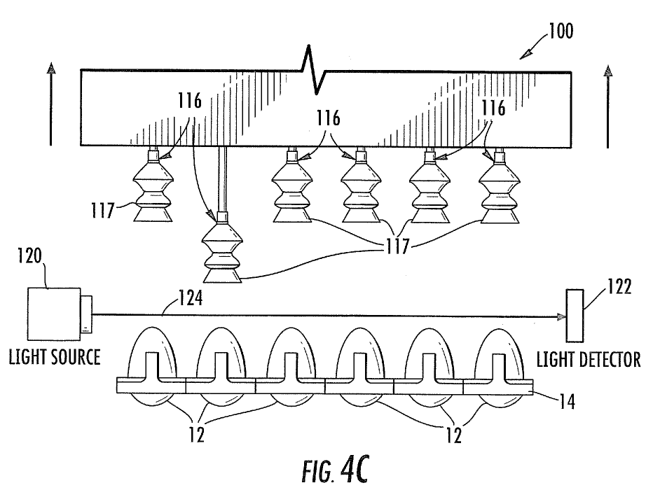

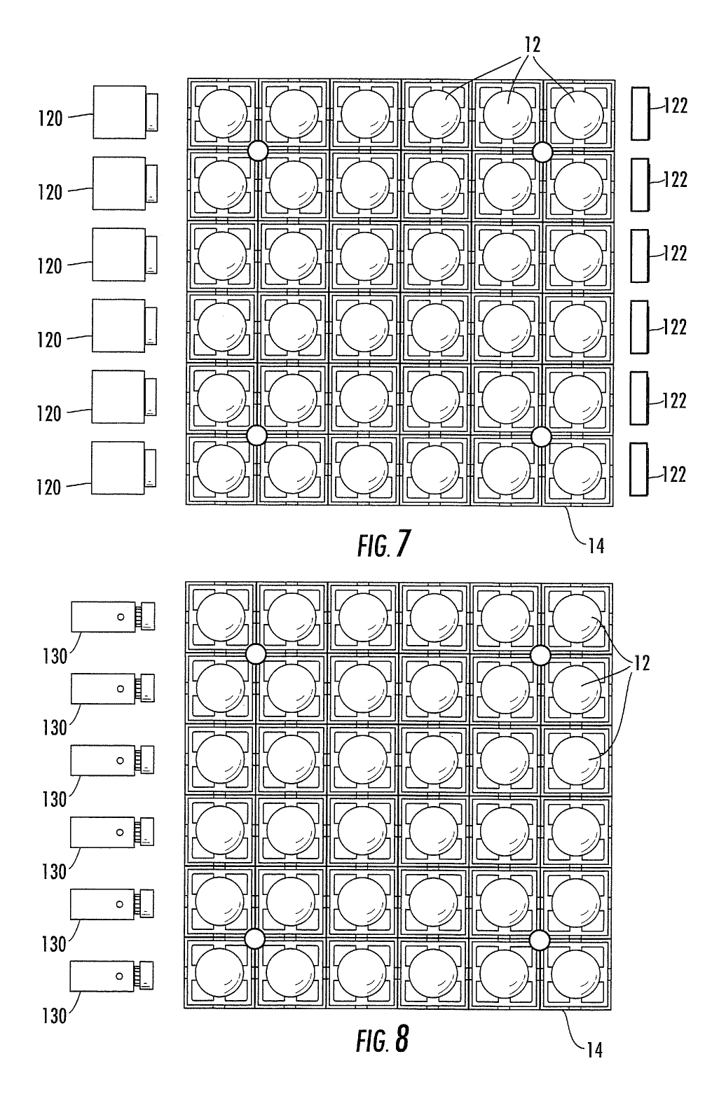

Referring to FIGS. 5 and 6, methods and apparatus for determining if eggs designated for removal have, in fact, been removed from an egg carrier, according to other embodiments of the present invention are illustrated. Instead of a light source/detector pair for each row of a carrier, the illustrated egg removal apparatus 200 utilizes an optical camera 130 positioned adjacent each row (see FIG. 8). Each camera 130 is positioned on one side of the carrier 14, as illustrated, but does not require a separate detector. Each camera 130 is configured to capture an optical path 134 that extends above and across the carrier. Each camera 130 is configured to measure a length of time that an optical path 134 is blocked when the egg picker 116 is moved from the first location to the second location and back towards the first location.

According to some embodiments of the present invention, each camera 130 is configured to generate a signal that indicates whether or not eggs designated for removal in a row have in fact been removed based on the length of time the optical path 134 is blocked. For example, each camera 130 can generate a signal that indicates that eggs in a respective row designated for removal have been removed from the carrier 14 when the measured length of time that the optical path 134 is blocked is greater than a predetermined length of time. (FIG. 6 illustrates the successful removal of an egg). Similarly, each camera 130 can generate a signal that indicates that one or more eggs designated for removal in a respective row have not been removed from the carrier 14 when the measured length of time that the optical path is blocked is less than a predetermined length of time. Signals generated by each camera 130 may be communicated to a controller for the egg removal apparatus 100, to a user interface, and/or to an alarm, as described above.

Embodiments of the present invention are not limited to the illustrated arrangement of cameras 130. According to other embodiments of the present invention, another set of cameras may also be utilized along the carrier rows that are oriented orthogonal to the carrier rows of FIG. 8 having cameras 130 positioned adjacent thereto. In some embodiments, a camera may be positioned above an egg carrier to confirm that eggs designated for removal have, in fact, been removed.

According to other embodiments of the present invention, the camera 130 of FIGS. 5 and 6 can be replaced with other types of detectors (e.g., reflective detectors, etc.) that are configured to monitor a path above and across an egg carrier and to measure a length of time that the path is blocked when an egg picker is moved from the first location to the second location and back towards the first location. These detectors may also be configured to generate a signal that indicates whether or not an egg has been removed from the carrier based on the length of time the path is blocked.

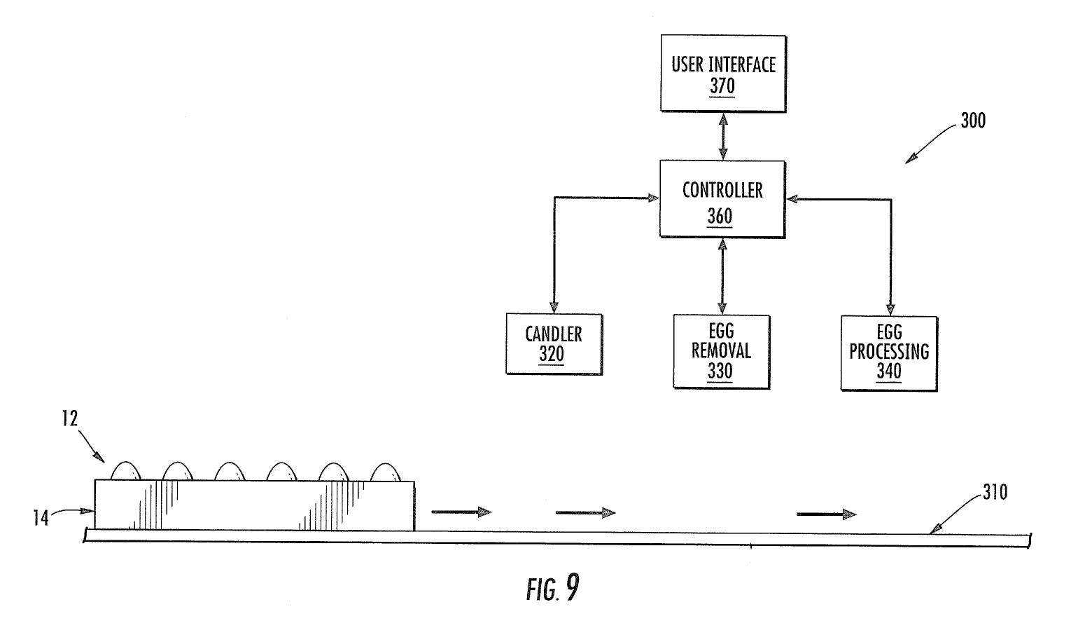

Referring to FIG. 9, a block diagram of an egg processing system 300, according to some embodiments of the present invention, is illustrated. The illustrated system 300 includes a conveyor system 310 that conveys flats (or other carriers) 14 of eggs 12, and a candling station 320, operably associated with the conveyor system 310 and with a controller 360, that identifies live/non-live eggs and designates eggs to be removed from a carrier 14. The illustrated system 300 also includes an egg removal station 330 that is configured to selectively remove eggs (e.g., live or non-live eggs, etc.) from an egg carrier 14, and an egg processing station 340. Egg removal station 330 may include egg removal apparatus 100, 200 described above for determining whether or not eggs designated for removal have been removed.

In operation, a flat 14 of eggs 12 is conveyed from an incubator to the candling station 320 via the conveyor system 310. Various types of conveyor systems may be utilized with embodiments of the present invention. Egg conveying systems are well known to those of skill in the art and need not be described further herein. The candling station 320 identifies live eggs and non-live eggs and designates eggs to be removed from the carrier 14.

Eggs designated for removal are removed from the flat 14 via egg removal station 330. Verification of whether or not eggs designated for removal have, in fact, been removed is performed as described above. If one 30 ore more eggs are unsuccessfully removed, an operator may be notified and/or another attempt at removal may be undertaken.

Flat 14 at this point on the conveyor 310 proceeds to processing station 340 (e.g., inoculation, vaccine production, material sampling, etc.). An exemplary processing station 340 is the INOVOJECT® automated injection system (Embrex, Inc., Research Triangle Park, N.C.). However, various other processing stations capable of in ovo delivery and/or removal may be used in accordance with some embodiments of the present invention.

The controller 360 controls operations of the candling station 320, the conveyor system 310, the egg removal station 330, and the egg processing station 340. An operator interface (e.g., a display) 370 may be provided to allow an operator to interact with the controller 360. The interface 370 may be configured to display or otherwise indicate eggs that were unsuccessfully removed from the carrier 14.

Embodiments of the present invention are advantageous in that egg pickers that are not working correctly/accurately (i.e., failing to remove eggs designated for removal) can be quickly identified and fixed. The vacuum lines and/or venturis of egg pickers can become plugged with a mixture of egg goo, egg shell dust, and other debris, and when this happens an egg picker will subsequently miss most or all the eggs it tries to remove.

In flu virus harvesting environments, the top of an egg is punched and, as a result, egg pickers may experience more goo and debris than in environments where non-punched eggs are to be removed. Also in the flu vaccine harvesting industry, producers want to reduce the number of workers exposed to the vaccine harvesting environment, particularly for H5N1 viruses (bird flu), so it is important to be able to automatically detect a plugged egg picker and notify an operator so that the egg picker can be cleaned/fixed so that it does not fail to remove eggs from that point on.

Embodiments of the present invention can quickly and accurately identify malfunctioning egg pickers by tracking the number of egg removals each egg picker attempts and the number of unsuccessful egg removals, signaling when unsuccessful egg removals exceed some number per unit time (like more than two failed egg removals in an hour) or failed egg removals exceed some percentage of total egg removals (like failed egg removals are more than 10%, etc.), or a combination thereof. In cases where more than one egg is to be removed from a row and neither is removed, these systems can tally missed picks for both pickers.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An apparatus for removing eggs from an egg carrier, comprising:
an egg picker movable between a first location and a second location in contacting relationship with an egg in the carrier, wherein the egg picker is configured to engage the egg when in the second location and to remove the egg from the carrier when moved from the second location towards the first location;
a light source positioned on one side of the carrier, wherein the light source emits light along a path above and across the carrier; and
a light detector positioned on an opposite side of the carrier, wherein the light detector is configured to measure a length of time that the light path is blocked when the egg picker is moved from the first location to the second location and back towards the first location.

2. The apparatus of claim 1, wherein the light detector generates a signal that indicates whether or not the egg has been removed from the carrier based on the length of time the light path is blocked.

3. The apparatus of claim 1, wherein the light detector generates a signal that indicates that the egg has not been removed from the carrier when the measured length of time that the light path is blocked is less than a predetermined length of time.

4. The apparatus of claim 3, further comprising an alarm that is activated in response to the generation of the signal.

5. The apparatus of claim 1, wherein the light detector generates a signal that indicates that the egg has been removed from the carrier when the measured length of time that the light path is blocked is greater than a predetermined length of time.

6. The apparatus of claim 1, wherein the egg picker comprises a flexible cup that is configured to engage and retain an egg in seated relation therewith when subatmospheric pressure is provided within the flexible cup.

7. The apparatus of claim 2, further comprising a user interface in communication with the light detector, and wherein the user interface displays an indication whether or not the egg has been removed.

8. An apparatus for removing eggs from an egg carrier, comprising:
an egg picker movable between a first location and a second location in contacting relationship with an egg in the carrier, wherein the egg picker is configured to engage the egg when in the second location and to remove the egg from the carrier when moved from the second location to the first location;
a detector positioned adjacent to the carrier, wherein the detector is configured to monitor a path above and across the carrier and to measure a length of time that the path is blocked when the egg picker is moved from the first location to the second location and back towards the first location.

9. The apparatus of claim 8, wherein the detector generates a signal that indicates whether or not the egg has been removed from the carrier based on the length of time the path is blocked.

10. The apparatus of claim 8, wherein the detector generates a signal that indicates that the egg has not been removed from the carrier when the measured length of time that the path is blocked is less than a predetermined length of time.

11. The apparatus of claim 10, further comprising an alarm that is activated in response to the generation of the signal.

12. The apparatus of claim 8, wherein the detector generates a signal that indicates that the egg has been removed from the carrier when the measured length of time that the path is blocked is greater than a predetermined length of time.

13. The apparatus of claim 8, wherein the detector comprises a camera positioned on one side of the carrier, wherein the camera captures an optical path that extends above and across the carrier, wherein the camera is configured to measure a length of time that the optical path is blocked when the egg picker is moved from the first location to the second location and back towards the first location.

14. The apparatus of claim 8, wherein the egg picker comprises a flexible cup that is configured to engage and retain an egg in seated relation therewith when subatmospheric pressure is provided within the flexible cup.

15. The apparatus of claim 8, further comprising a user interface in communication with the detector, and wherein the user interface displays an indication whether or not the egg has been removed.

16. A method of removing eggs from an egg carrier, comprising:
emitting light along a path above and across an egg carrier;
moving an egg picker from a first location to a second location in contacting relationship with an egg in the carrier and back towards the first location, wherein the egg picker is configured to engage the egg when in the second location and remove the egg from the carrier when moved from the second location towards the first location; and
measuring a length of time that the light path is blocked when the egg picker is moved from the first location to the second location and back towards the first location.

17. The method of claim 16, further comprising generating a signal that indicates whether or not the egg has been removed from the carrier based on the length of time the light path is blocked.

18. The method of claim 16, further comprising generating a signal that indicates that the egg has not been removed from the carrier when the measured length of time that the light path is blocked is less than a predetermined length of time.

19. The method of claim 16, wherein a light source positioned on one side of the carrier emits light along a path above and across the carrier, and wherein a light detector positioned on an opposite side of the carrier measures a length of time that the light path is blocked when the egg picker is moved from the first location to the second location and back towards the first location.

20. A method of removing eggs from an egg carrier, comprising:
monitoring an optical path above and across an egg carrier;
moving an egg picker from a first location to a second location in contacting relationship with an egg in the carrier and back to the first location, wherein the egg picker is configured to engage the egg when in the second location and remove the egg from the carrier when moved from the second location to the first location; and
measuring a length of time that the optical path is blocked when the egg picker is moved from the first location to the second location and back towards the first location.

21. The method of claim 20, further comprising generating a signal that indicates whether or not the egg has been removed from the carrier based on the length of time the optical path is blocked.

22. The method of claim 20, further comprising generating a signal that indicates that the egg has not been removed from the carrier when the measured length of time that the optical path is blocked is less than a predetermined length of time.

23. The method of claim 20, wherein a camera positioned on one side of the carrier monitors the optical path and measures a length of time that the optical path is blocked when the egg picker is moved from the first location to the second location and back towards the first location.

24. A method of detecting a malfunctioning egg picker in an apparatus for removing eggs from an egg carrier, wherein the apparatus includes a plurality of egg pickers that are movable between a first location and a second location in contacting relationship with a respective plurality of eggs in the carrier, wherein each egg picker is configured to engage a respective egg when in the second location and to remove the egg from the carrier when moved from the second location towards the first location, the method comprising:
counting the number of times an egg picker fails to remove an egg designated for removal from the carrier; and
generating a signal that indicates that the egg picker is malfunctioning when the number of times exceeds a predetermined number.

25. The method of claim 24, wherein counting the number of times an egg picker fails to remove an egg designated for removal from the carrier is performed by an optical system positioned adjacent to the carrier.
